(19) United States
(12) Patent Application Publication
(10) Pub. No.: US 2017/0137912 A1
(43) Pub. Date: May 18, 2017

(54) PROCESS AND APPARATUS FOR DRY GRANULATION OF SLAG WITH REDUCED FORMATION OF SLAG WOOL

(71) Applicants: HATCH LTD., Mississauga (CA); ECOMAISTER CO., LTD., Incheon, Gyeonggi-do (KR)

(72) Inventors: Santiago Faucher, Oakville (CA); Sang-Yoon Oh, Gyeonggi-do (KR); Sina Mostaghel, Toronto (CA); Lai Chi So, Toronto (CA); Victor Hernandez, Burlington (CA); Maurizio Darini, Toronto (CA); Darryl Robert Metcalfe, Stouffville (CA); Tom Rafferty, Mississauga (CA)

(21) Appl. No.: 14/915,451

(22) PCT Filed: Mar. 20, 2015
(86) PCT No.: PCT/CA2015/050210

§ 371 Date: Feb. 29, 2016

Related U.S. Application Data
(60) Provisional application No. 62/007,284, filed on Jun. 3, 2014.

(51) Int. Cl. C22B 7/04; C04B 5/00; C21B 3/08

(52) U.S. Cl. CPC C22B 7/04; C21B 3/08; C04B 5/00

(57) ABSTRACT

A process for producing substantially dry slag granules comprises adding a controlled amount of water to a molten stream of slag, and granulating the slag to produce solidified slag comprising substantially dry slag granules and slag wool. An apparatus for producing substantially dry slag granules comprises: (a) an inclined surface having an upper and lower ends for receiving and discharging the stream of slag; (b) a dispersion device at the lower end of the inclined surface for dispersion of the molten slag; (c) one or more water addition devices for adding a controlled amount of water to the molten slag; and (d) a collection area adjacent to the dispersion device for deposition of solidified slag produced by the dispersion. The quantity of slag wool produced by the process and apparatus is less than that which would be produced without the addition of water.

### CROSS-REFERENCE TO RELATED APPLICATIONS

This application claims priority to and the benefit of U.S. Provisional Patent Application No. 62/007,284 filed Jun. 3, 2014, the contents of which are incorporated herein by reference.

### BACKGROUND OF THE INVENTION

1. Field of the Invention

The present disclosure relates to granulated slag products and processes for their production.

2. Field of the Invention

Slag is a by-product of metal production processes conducted in metallurgical furnaces. Although the composition and quantity of slag produced is highly dependent on the specific process, slag typically comprises a mixture of metal oxides with silica, and is produced in amounts ranging from roughly 10 percent to several times the amount of metal produced by the process.

During metal production, slag is present in the metallurgical furnace in molten form. Molten slag is periodically tapped from the furnace and may be processed into a granulated slag product. Granulated slag has been used as an aggregate for concrete and as a cementitious material, and recently there has been interest in the use of granulated slag as proppants in oil and gas production, as roofing granules, abrasives or as catalyst supports.

Slag granulation is typically performed by a wet granulation process, conducted using water sprays which contact the stream of slag, and disperse it into droplets which solidify into granules that are conveyed down the sluicing launder, and then to a yard where they land in a pond for collection.

During the wet granulation process, large amounts of water are added to the slag to cool the molten slag. The waste water produced by the process is contaminated by contact with the slag and its disposal results in additional cost. Furthermore, water granulation often results in the production of slag granules which have an unacceptably high water content and which are considered unfit for many uses. The drying of wet slag granules also results in additional cost, and in many cases is not economically feasible. Attempts to address this problem by controlling the amounts of water added to the granulation process have met with limited success. Wet granulation of sulfur-containing slags has also been known to produce unacceptably high emissions of sulfur-containing gases.

Dry granulation of slag overcomes some of the problems associated with the wet granulation process. In a dry granulation process, the molten slag is typically dispersed or atomized by a pressured gas stream, or by mechanical means. Although dry granulation uses less water than wet granulation, and typically produces a dry product, the dry granulation process can produce large quantities of slag “wool”, consisting of low density fibers of slag produced when the slag has poor droplet-forming properties. The slag wool has low density and high volume, making its handling, transportation, and recovery difficult. In extreme cases, the amount of slag wool formation may be as high as 90% by weight. The production of slag wool is particularly problematic for slags having high viscosity, and has limited the application of dry granulation, and in particular gas atomization, to specific types of slag which have a low tendency to produce slag wool.

Also, it is difficult to process slag at high flow rates in a gas atomization apparatus, due to the tendency of the slag to gather into thick streams which are difficult to disperse with air. Furthermore, the thickness of the slag stream affects the size of the particles produced by air atomization. Therefore, inconsistency in the thickness of the slag stream can result in a lack of control over the particle size of the slag granules, and can result in products having a very broad particle size distribution. To avoid these issues, gas atomization processes tend to operate on a small scale, limiting their usefulness.

There remains a need for simple, economically feasible processes for slag granulation which avoid the above-mentioned problems associated with known wet and dry granulation processes.

### SUMMARY OF THE INVENTION

In one aspect, there is provided a process for the production of substantially dry slag granules. The process comprises: (a) providing a stream of molten slag, which may comprise a metallurgical slag; (b) adding a controlled amount of water to the slag; (c) granulating the stream of molten slag to produce solidified slag; wherein the solidified slag comprises said substantially dry slag granules and slag wool, and wherein a quantity of the slag wool produced by the process is less than that which would be produced by granulating the stream of molten slag without addition of the controlled amount of water. For example, the quantity of the slag wool produced by the process is less than about 10 percent by weight of the solidified slag.

In an embodiment, the controlled amount of water is less than about 300 kg water per tonne of slag, and may be less than about 100 kg water per tonne of slag. For example, the controlled amount of water may be such that the substantially dry slag granules have a water content of less than about 5 percent by weight.

In another embodiment, the step of granulating the stream of molten slag comprises dispersion of the molten slag by contact of the molten slag with a stream of an atomizing fluid, which may comprise gas.

In yet another embodiment, at least a portion of the controlled amount of water is added to the slag simultaneously with the contact of the molten slag with the atomizing fluid, such that the atomizing fluid may further comprise the controlled amount of water.

In yet another embodiment, at least a portion of the controlled amount of water is added to the molten slag prior to the contact of the molten slag with the atomizing fluid.

In yet another embodiment, at least a portion of the controlled amount of water is added to the molten slag immediately after the contact of the molten slag with the atomizing fluid, as the dispersed slag is projected through an atomizing chamber and before it lands in a collection area of the atomizing chamber.

In yet another embodiment, the step of granulating the stream of molten slag comprises dispersion of the molten slag by contact of the molten slag with a rotating mechanical element.

In another aspect, there is provided an apparatus for the production of substantially dry slag granules. The apparatus comprises: (a) an inclined surface having an upper end for receiving a stream of molten slag and a lower end for discharging the stream of molten slag; (b) a dispersion device at the lower end of the inclined surface for dispersion of the stream of molten slag discharged from the inclined surface; (c) one or more water addition devices for adding a controlled amount of water to the molten slag; and (d) a collection area adjacent to the dispersion device for deposition of solidified slag produced by the dispersion of the molten slag, wherein the solidified slag comprises said substantially dry slag granules and slag wool, and wherein a quantity of the slag wool is less than that which would be produced by granulating the stream of molten slag without addition of the controlled amount of water.

In one embodiment, the dispersion device comprises an atomizer in which the molten slag is contacted with a stream of an atomizing fluid. For example, the dispersion device may comprise a gas atomizer and the atomizing fluid may comprise gas.

In another embodiment, at least one of said water addition devices is located proximate to the lower end of the inclined surface and is associated with the gas atomizer, such that the gas and the controlled amount of water added by said at least one water addition device together comprise the atomizing fluid.

In yet another embodiment, the gas atomizer comprises a blower, and the at least one water addition device located proximate to the lower end of the inclined surface comprises one or more spray nozzles, said spray nozzles being located above and/or below the lower end of the inclined surface.

In yet another embodiment, the dispersion device comprises a first rotating mechanical element, and wherein at least one of said water addition devices are located between the upper end of the inclined surface and the first rotating mechanical element.

In yet another embodiment, a slag flow direction is defined between upper and lower ends of the inclined surface, and the inclined surface has a width which is transverse to the slag flow direction; the apparatus further comprises a flow distribution element, for distributing the flow of the molten slag across the width of the inclined surface; and the flow distribution element is located between the upper end of the inclined surface and the first rotating mechanical element.

In yet another embodiment, the one or more water addition devices are located along the slag flow direction between the upper end of the inclined surface and the flow distribution element.

In yet another embodiment, the one or more water addition devices comprises one or more water spray nozzles provided above the inclined surface and directed downwardly toward the inclined surface.

In yet another embodiment, the flow distribution element comprises a second rotating mechanical element which extends across the width of the inclined surface, is rotatable about an axis extending transversely across the inclined surface, and extends across substantially the entire width of the inclined surface, and is spaced from the inclined surface by a gap.

In yet another embodiment, the flow distribution element is cylindrical.

In another aspect, there is provided an apparatus for the production of substantially dry slag granules, comprising: (a) an inclined surface having an upper end for receiving a stream of molten slag and a lower end for discharging the stream of molten slag, wherein a slag flow direction is defined between upper and lower ends of the inclined surface, and the inclined surface has a width which is transverse to the slag flow direction; (b) a gas atomizer proximate to the lower end of the inclined surface for dispersion of the stream of molten slag discharged from the inclined surface with an atomizing gas; (c) a flow distribution element for distributing the flow of the molten slag across the width of the inclined surface, wherein the flow distribution element is located between the upper end and the lower end of the inclined surface; and (d) a collection area adjacent to the gas atomizer for deposition of solidified slag produced by the dispersion of the molten slag, wherein the solidified slag comprises said substantially dry slag granules.

In an embodiment, the flow distribution element comprises a rotating mechanical element which extends across the width of the inclined surface, is rotatable about an axis extending transversely across the inclined surface, extends across substantially the entire width of the inclined surface, and is spaced from the inclined surface by a gap. For example, the flow distribution element may be cylindrical.

In another embodiment, the gas atomizer is located below the lower end of the inclined surface.

In yet another embodiment, the apparatus further comprises one or more water addition devices located proximate to one or more of the upper surface of the inclined surface, the flow distribution element, and/or the gas atomizer, for the purpose of adding water to the molten slag before, during and/or after granulation of the molten slag.

In yet another aspect, there is provided a process for the production of substantially dry slag granules, comprising: (a) providing a stream of molten slag flowing along an inclined surface having an upper end for receiving the stream of molten slag and a lower end for discharging the stream of molten slag, wherein a slag flow direction is defined between upper and lower ends of the inclined surface, and the inclined surface has a width which is transverse to the slag flow direction; (b) distributing the flow distribution of the molten slag across the width of the inclined surface with a flow distribution element located between the upper end and the lower end of the inclined surface, so as to provide the stream of molten slag with a uniform thickness at the lower end of the inclined surface; and (c) dispersing the stream of molten slag with an atomizing gas from a gas atomizer immediately after the stream of molten slag is discharged from the lower end of the inclined surface. The process may further comprise the addition of water to the molten slag in an amount up to about 1.2 tonnes of water per tonne of slag, wherein the water is added before, during and/or after the step of dispersing the stream of molten slag.

### BRIEF DESCRIPTION OF THE DRAWINGS

The invention will now be described, by way of example only, with reference to the attached drawings, in which:

FIG. 1 illustrates an apparatus for production of substantially dry slag granules according to an embodiment.

### DESCRIPTION OF THE PREFERRED EMBODIMENT(S)

The following is a detailed description of processes and apparatus for producing substantially dry slag granules from molten slag produced by metallurgical processes. The dry slag granules may be suitable for use as proppants for oil and gas recovery, roofing granules, catalyst supports, abrasives, concrete aggregates, and/or cementitious materials.

The starting materials used in the processes described herein are slag compositions. Typically these slag compositions are by-products from processes for metal production. Slag compositions for use in the processes described herein can have various compositions, depending on the processes from which they originate.

The slag compositions used herein can be of various compositions and viscosities, and include ferrous and non-ferrous slags. Ferrous slags are produced in ironmaking and steelmaking and typically comprise lime, silica, alumina and magnesia, and may also comprise free iron. Non-ferrous slags are produced in smelting processes for production of non-ferrous metal such as copper, nickel and lead. Non-ferrous slags may comprise varying amounts of silica, iron oxide, magnesia and lime, and tend to be more acidic than ferrous slags, due to a higher ratio of SiO₂/CaO (i.e. lower basicity).

Slag is maintained within the metallurgical furnace in a molten state. The molten slag is periodically tapped from the furnace, into a movable slag vessel or a slag launder or runner, in which the molten slag is transported to another area of the plant.

In the present process, a stream of molten slag is granulated to produce solidified, dry slag granules. Typically, the stream of molten slag is transferred directly from a metallurgical furnace to the granulation apparatus, so as to minimize heat loss and solidification of the molten slag, and to avoid additional costs involved in crushing and re-melting solidified slag. However, this is not essential to operation of the process.

In some aspects of the present process, a controlled amount of water is added to the slag for the purpose of reducing wool formation. The controlled amount of water for reducing wool formation is less than about 300 kg per tonne of slag, i.e. less than about 30 percent by weight. More typically, the controlled amount of water which is added to the slag to reduce wool formation is less than about 100 kg per tonne of slag (10 percent by weight), or less than about 50 kg per tonne of slag (5 percent by weight). Where water is added for reduction of wool formation, the lower limit of water addition for this purpose is about 5 kg per tonne of slag.

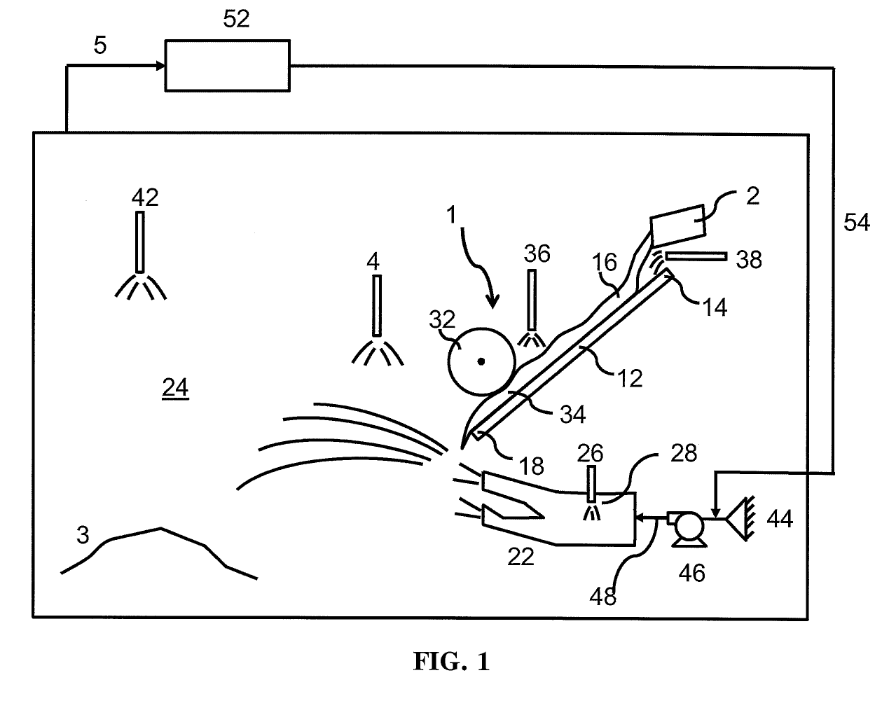

In other aspects of the present process, the slag may not be susceptible to wool formation, in which case it may not be necessary to add any water for the purpose of reducing wool formation. For example, certain slags from processes for producing steel, zinc or copper may not require water addition for reducing wool formation. This aspect of the process is further discussed below, in connection with the apparatus shown in FIG. 1.

The total amount of water added to the slag in the present process may include an amount of water for expansion of the slag, for example where lightweight slag granules are the desired product. The typical amount of water added for slag expansion is from about 200-800 kg per tonne of slag (20-80 percent). Even with the addition of water for expansion, the present process uses substantially less water than conventional wet granulation processes, which typically use about 6-10 tonnes of water per tonne of slag.

Where the slag being granulated is susceptible to wool formation, the inventors have found that the addition of water in the above amounts results in a significant reduction in the formation of slag wool, the reductions being on the order of at least about 30-50 weight percent relative to equivalent gas atomization processes in which the slag is not conditioned by addition of water. The amount of reduction is at least partly dependent on the degree of slag wool formation in the absence of water. The inventors have found that it is possible to reduce the production of slag wool in some processes to levels as low as about 5 percent by weight of the solidified slag, meaning that the solidified slag is predominantly comprised of slag granules.

Furthermore, the slag granules produced by the present process are “dry” granules, having a water content of less than about 5 percent by weight, more typically less than about 2 percent by weight.

Although not wishing to be bound by theory, the inventors believe that the addition of water in the above amounts may reduce the viscosity of the slag, thereby reducing its tendency to form slag wool upon dispersion. This is somewhat surprising, and counter-intuitive, since one would expect that the addition of water would have the opposite effect, i.e. that water addition would cause the slag to cool and become more viscous.

Again, without wishing to be bound by theory, the inventors believe that viscosity reduction may result from the breakup of silicate networks in the slag. In this regard, the high viscosity of some slags, particularly acidic non-ferrous slags, is believed to be a result of the presence of polymerized silicate networks, i.e. connected SiO₄⁻⁴ tetrahedral units, in these slags. Non-ferrous slags therefore have poor dispersibility, which has limited the production of saleable granular products from these types of slags.

At least some of the water added to the hot slag for the purpose of reducing wool formation dissociates into elemental hydrogen and oxygen and reacts with the bridging oxygen atoms in the silicate network to form hydroxides. This is believed to break down the silicate network and reduce the degree of polymerization in the slag, thereby reducing the viscosity of the slag and reducing the tendency of the slag to form slag wool upon dispersion.

In addition to viscosity reduction, the inventors believe that the addition of water to slag in the above-defined amounts may also have other benefits, including increased density, increased fluidity and increased superheat.

Increased density of the slag is also believed to result from the breakup of silica networks. This results in a reduction of the molar volume of the system, which is the reciprocal of density.

Increased fluidity is inversely proportional to the kinematic viscosity of the melt (viscosity/density). A decreased viscosity and increased density will reduce the kinematic viscosity and thereby increase the fluidity of the melt. The increased fluidity is expected to reduce the tendency of the slag to form slag wool during dispersion.

The superheat is defined as the difference between the liquidus temperature of the slag and the operating temperature of the slag. Water dissolution into acidic slag reduces its liquidus temperature, thereby resulting in an increased superheat. A higher superheat results in lower viscosity, increased fluidity, easier dispersibility, and reduced slag wool formation.

The atomization of viscous slags may also be brought about by physical fragmentation of the slag, for example by hydraulic shock, film-boiling instabilities, and micro-explosions.

For example, addition of water into the dispersion medium increases its momentum, resulting in “hydraulic shock”, which assists in breaking down the filaments of molten slag into droplets.

Film-boiling instability results from a film of water vapour on the surface of the molten slag. Oscillation of the film thickness causes sufficient momentum to the melt so that its surface distorts into waves that will grow and detach, forming small fragments. The film waves will be propagated and enlarged until they collapse, resulting in further fragmentation of slag filaments.

Micro-explosions are caused by superheating of water which is intimately mixed with slag, resulting in additional fragmentation of slag filaments.

Regardless of the mechanism by which dispersibility is improved, the present process is applicable to a wide range of slags, having varying degrees of viscosity. Some of these slags have not been effectively processed into saleable products in the past.

According to the present process, the stream of molten slag is granulated to produce a solidified slag, which will include substantially dry slag granules and which may or may not include some amount of slag wool. The means by which the slag is granulated is variable.

In some embodiments, the stream of molten slag is dispersed by contact of the molten slag with a stream of an atomizing fluid. The atomizing fluid may comprise a stream of gas from one or more blowers or nozzles, the fluid being directed at the stream of molten slag as it falls through an atomization chamber. The atomizing fluid simultaneously disperses the slag into droplets and cools the droplets into a solid state, thereby forming solid slag granules. Dispersion of the molten slag with an atomizing fluid results in solid slag granules having a relatively small particle size and narrow particle size distribution. Such particles have a variety of end uses, including slag proppants, roofing granules and catalyst supports.

In other embodiments, the stream of molten slag is dispersed by contact of the molten slag with a rotating mechanical element located within a chamber. Numerous types of rotating elements are known in the prior art, including rotating plates, rotating vaned drums or impellers, etc. In this type of apparatus, the molten slag comes into contact with the rotating element and is projected through the chamber, which causes the slag to separate into droplets and solidify into granules before landing in a heap in a collection area. Dispersion of the molten slag by a rotating mechanical element results in slag granules having relatively wide particle distribution and a diameter up to about 21 mm. Such particles may be used as aggregate in concrete compositions.

The controlled amount of water for reducing slag wool formation may be added at one or more stages in the process. In particular, the controlled amount of water may be added prior to, simultaneously with, and/or immediately after the dispersion of the slag. For example, where the molten slag is dispersed by contact with an atomizing fluid, the controlled amount of water may be added to the slag simultaneously and/or immediately after the contact of the molten slag with the atomizing fluid, as the dispersed slag is projected through the atomizing chamber and before it lands in the collection area of the atomizing chamber. When the slag is simultaneously contacted with the atomizing fluid and the controlled amount of water, it will be appreciated that the water may be incorporated into the atomizing fluid.

The controlled amount of water may instead be added to the molten slag before the granulation step. The increased residence time of the water in or on the molten slag prior to dispersion may be beneficial in some types of slags, although the inventors have observed that improved dispersibility and reduced wool formation are provided in cases where the controlled amount of water is added simultaneously with, immediately before, and/or immediately after the granulation step.

As mentioned above, the present process is adaptable to a wide range of slag compositions, and is capable of producing slag granules of a variety of sizes. It will be appreciated that various other modifications can be made to the molten slag to render it suitable for specific applications. These modifications include expansion of the slag to produce granules of varying density, as well as modifications to alter the chemical composition and shape of the granules. These modifications are discussed in greater detail in U.S. provisional application No. 62/007,180 filed on Jun. 3, 2014 and entitled “GRANULATED SLAG PRODUCTS AND PROCESSES FOR THEIR PRODUCTION”, which is incorporated herein by reference in its entirety.

As an added benefit, the present process may result in reduced emissions of sulfur-containing gases such as sulfur dioxide and hydrogen sulfide, as compared to wet granulation processes. In this regard, air atomization of slag oxidizes sulfur in the slag and also alters the properties of the slag so that it has a greater capacity to absorb sulfur. As a result, more sulfur remains in the slag, and less is emitted as SO₂ or H₂S.

The apparatus for performing the process described above is now described with reference to the drawing.

FIG. 1 schematically illustrates an apparatus 10 for production of substantially dry slag granules. The apparatus 10 comprises an inclined surface 12 having an upper end 14 for receiving a stream of molten slag 16 and a lower end 18 for discharging the stream of molten slag 16. The surface 12 is inclined so as to permit gravity flow of the stream of slag 16 from the upper end 14 to the lower end 18 of the inclined surface 12. Therefore, a slag flow direction is defined between the upper and lower ends 14, 18 of the inclined surface 12. The slag flow rate is typically about 0.1-10 tonnes/min at an inclination angle of about 45 degrees. The inclined surface 12 may have a width of about 0.2-4 metres and a length of about 1.5-2 metres, with the residence time of the slag flowing along surface 12 being about 3-10 seconds. It will be appreciated that these parameters are somewhat dependent on the slag properties.

The inclined surface 12 is comprised of a heat-resistant material and may comprise the planar base of a feed trough having sides (not shown) to retain the stream of molten slag 16. Molten slag is transported from a metallurgical furnace (not shown) to apparatus 10 by a slag vessel or launder 20, which feeds the molten slag to the upper end 14 of the inclined surface 12.

A dispersion device is located at or below the lower end 18 of the inclined surface 12. In the present embodiment, the dispersion device comprises an atomizer 22 which is located immediately below the lower end 18 of the inclined surface 12, in an atomization chamber 24. The atomizer 22 directs a stream of an atomizing fluid at the molten slag stream 16 as it is discharged from the lower end 18 of the inclined surface 12 and falls through the chamber 24.

The atomizer 22 comprises a gas inlet 44, an atomizing blower 46, an atomization nozzle 23 having a width which is substantially the same as the width of the inclined surface 12, and ducting 48 which connects the atomizing blower 46 to the atomization nozzle 23. The atomizing fluid is of variable composition, and may include one or more of air, steam, liquid water, inert gas, recycled process gases, etc. The gas may be compressed air or air at ambient pressure. For example, where the gas is at ambient pressure, the atomizer 22 may comprise a common blower 46, which may produce a maximum total pressure rise of less than about 80 inches of water, or about 20 kPa.

When the atomizing fluid contacts the falling stream of molten slag 16, it disperses the molten slag into droplets which are projected through the chamber 24. The droplets cool and solidify as they are projected through chamber 24, and land in a collection area 30 adjacent to the atomizer 22. The solidified slag deposited in collection area 30 and predominantly comprises substantially dry slag granules.

The apparatus 10 further comprises a flow distribution element to distribute or spread the flow of the molten slag across the width of the inclined surface 12, wherein the width is defined transversely to the slag flow direction. As mentioned above, slag has a tendency to gather into thick streams which are difficult to disperse with air, thereby limiting the ability of the dry granulation apparatus to process slag at high flow rates, and limiting its scale. The inventors have found that the incorporation of a flow distribution element into apparatus 10 distributes the flow of the molten slag across the width of the inclined surface 12, so as to reduce the thickness of the slag stream 16 and make it easier to disperse once it reaches the atomizer 22. The flow distribution element helps to ensure that the thickness of the slag stream 16 discharged from the lower end 18 of the inclined surface 12 is relatively uniform across the width of the inclined surface 12 and across the width of the atomizer nozzle 23. As explained above, this helps to control the particle size and the particle size distribution of the slag granules. Also, by making the thickness of the slag stream more uniform, the flow distribution element helps to reduce the amount of slag wool produced by the atomizer 22, regardless of whether a controlled amount of water is required for the purpose of reducing slag wool formation.

The flow distribution element may take a variety of forms, such as one or more upstanding ribs or other elements formed on the inclined surface 12 for distributing the slag flow, or a stationary bar or a rotating element located above the inclined surface 12 and extending across the width of the inclined surface 12. The flow distribution element is located between the upper and lower ends 14, 18 of the inclined surface, and also upstream of the atomizer 22. In the illustrated embodiment, the flow distribution element comprises a rotating element in the form of a cylindrical roller 32 having an axis of rotation extending across the width of the inclined surface 12. The roller 32 may be solid or may comprise a hollow, water-cooled drum, and may rotate in either a clockwise or counter-clockwise direction. The roller 32 extends across substantially the entire width of the inclined surface 12, and is spaced therefrom by a gap 34, so as to distribute the slag stream 16 evenly across the width of the inclined surface 12, and to reduce the thickness of the slag stream 16 to the height of gap 34. The height of roller 32 may be adjustable so that the height of the gap 34 may be adjusted for different types of slag. It can be seen that the flow distribution element permits the slag stream 16 to be made more uniform, such that the flow rate of slag across the width of the inclined surface 12 is relatively constant, and the capacity of the apparatus 10 is limited only by the width of the inclined surface 12 and the atomizer 22.

Where a controlled amount of water for reducing slag wool formation is required, it may be added at one or more locations in apparatus 10.

For example, some or all of the controlled amount of water may be added to the molten slag as it is being dispersed by the atomizer 22, and/or immediately after it is dispersed by the atomizer 22. For example, the water addition device(s) may be associated with the atomizer 22 such that the atomizing fluid comprises both an atomizing gas and water in gaseous and/or liquid form. In the illustrated embodiment, the water addition device comprises a water conduit 26 through which the atomizer 22 receives liquid water, and may further comprise one or more spray nozzles 28 through which water is dispersed into the air flow produced by the atomizer 22. Other possible additives to the atomizing fluid include carbon, metal carbonates and/or metal oxides, as more fully discussed in above-mentioned U.S. provisional application No. 62/007,180.

The apparatus 10 also includes one or more water nozzles 40 located in the atomization chamber 24, immediately downstream and above the lower end 18 of the inclined surface 12 and atomizer 22, through which a high pressure spray of water may be directed at the dispersed slag granules projected by atomizer 22, for the purpose of quenching and fragmenting the granules as they are projected through the chamber 24, and before they land in the collection area 30. In this way, the spray of water from nozzles 40 further helps to ensure production of a granular product while minimizing formation of slag wool.

The apparatus 10 may also include one or more water spray nozzles 36 located between the upper end 14 of the inclined surface 12 and the cylindrical roller 32, and which may be located immediately upstream of the roller 32. These nozzles 36 are spaced above and directed downwardly toward the inclined surface 12, and spray water on top of the slag stream 16. The water from nozzles 36 is predominantly diffused into the slag stream 16 and reacts with the slag to modify its thermo-physical properties as discussed above. In a given process, one or more sets of nozzles 28, 36, 40 may be activated. This provides flexibility as to the points at which the controlled amount of water is added to the slag stream 16.

In addition to the controlled amount of water which is added to modify the thermo-physical properties of the slag, apparatus 10 may include additional water addition devices which add water for other purposes. For example, in cases where it is desired to produce slag granules with reduced density, porous interiors, and/or porous exteriors, it may be desired to incorporate an additional amount of water into the slag for the purpose of slag expansion. For the purpose of this disclosure, any additional amounts of water added for the purpose of slag expansion are considered separate and distinct from the controlled amount of water which is added through one or more sets of nozzles 28, 36, 40 to modify the thermo-physical properties of the slag.

As shown in FIG. 1, apparatus 10 may include one or more water nozzles 38 at the upper end 14 of the inclined surface 12, in the area where the slag stream 16 is received from launder 20 and is deposited onto the inclined surface 12. The water from nozzles 38 is injected under the slag stream 16 at the upper end 14 of inclined surface 12, such that the water is predominantly converted to steam and forms voids and expands the slag as it rises upwardly through the slag stream 16. When the expanded slag is dispersed, it will produce slag granules with reduced density, having internal voids and optionally having a porous outer surface.

Apparatus 10 may also include one or more water nozzles 42 located in the atomization chamber 24, downstream of the atomizer 22, for the purpose of creating a mist for cooling gases which are generated during dispersion of the slag. The gases may be exhausted from chamber 24 through a duct 50 which is connected to an energy recovery device 52 for recovery of heat from the gases. The cooled gases generated by heat recovery device 52 may be recycled to the atomizing blower 46 through ducting 54.

Rather than atomizer 22, the apparatus 10 may include a rotating mechanical element (not shown) at the lower end 18 of the inclined surface to disperse the slag. The rotating element may comprise a rotating cylindrical drum having vanes on its outer surface, a spinning disc, a spinning cup, etc. Where the apparatus 10 includes a rotating element, the controlled amount of water is applied to the slag stream 16 through the one or more nozzles 36 located proximate to the cylindrical roller 32, and/or water nozzles 40 located immediately downstream of and above the lower end 18 of the inclined surface 12.

### EXAMPLE

A silicomanganese slag with a viscosity of about 2.03 poise and a temperature of about 1,500° C. was dispersed in an apparatus similar to apparatus 10, but without cylindrical roller 32. The flow rate of slag stream 16 along the inclined surface 12 was 2.0 ton/min. The atomizer 22 comprised an air blower producing a flow rate of atomization air of 1800 m³/min.

The slag stream 16 was first atomized without the use of water (water flow rate=0 kg water/ t slag). This resulted in formation of up to about 50 wt. % slag wool, the balance being slag granules.

The slag stream was then atomized with an atomizing fluid comprising air and water, wherein water was added to the air through spray nozzle 28 located at the atomizer. The water was injected into the atomization air flow at a rate of 100 kg/min (50 kg water/t slag). This resulted in a reduction in slag wool formation to less than 20 wt. %, with slag wool formation of less than 5 wt. % wool being achievable by optimization.

Although the invention has been described with reference to certain specific embodiments, it is not limited thereto. Rather, the invention includes all embodiments which may fall within the scope of the following claims.

What is claimed is:

1. A process for the production of substantially dry slag granules, comprising:
(a) providing a stream of molten slag;
(b) adding a controlled amount of water to the slag;
(c) granulating the stream of molten slag to produce solidified slag;
wherein the solidified slag comprises said substantially dry slag granules and slag wool, and wherein a quantity of the slag wool produced by the process is less than that which would be produced by granulating the stream of molten slag without addition of the controlled amount of water.

2. The process of claim 1, wherein the controlled amount of water is less than about 300 kg water per tonne of slag.

3. The process of claim 2, wherein the controlled amount of water is less than about 100 kg water per tonne of slag.

4. The process of any one of claims 1 to 3, wherein the controlled amount of water is such that the substantially dry slag granules have a water content of less than about 5 percent by weight.

5. The process of any one of claims 1 to 4, wherein the step of granulating the stream of molten slag comprises dispersion of the molten slag by contact of the molten slag with a stream of an atomizing fluid.

6. The process of claim 5, wherein the atomizing fluid comprises gas.

7. The process of claim 5 or 6, wherein at least a portion of the controlled amount of water is added to the slag simultaneously with the contact of the molten slag with the atomizing fluid.

8. The process of claim 7, wherein the atomizing fluid further comprises the controlled amount of water.

9. The process of any one of claims 5 to 8, wherein at least a portion of the controlled amount of water is added to the molten slag prior to the contact of the molten slag with the atomizing fluid.

10. The process of any one of claims 5 to 9, wherein at least a portion of the controlled amount of water is added to the molten slag immediately after the contact of the molten slag with the atomizing fluid, as the dispersed slag is projected through an atomizing chamber and before it lands in a collection area of the atomizing chamber.

11. The process of any one of claims 1 to 10, wherein the molten slag is a metallurgical slag.

12. The process of any one of claims 1 to 4 and 11, wherein the step of granulating the stream of molten slag comprises dispersion of the molten slag by contact of the molten slag with a rotating mechanical element.

13. The process of any one of claims 1 to 12, wherein the quantity of the slag wool produced by the process is less than about 10 percent by weight of the solidified slag.

14. An apparatus for the production of substantially dry slag granules, comprising:
(a) an inclined surface having an upper end for receiving a stream of molten slag and a lower end for discharging the stream of molten slag;
(b) a dispersion device at the lower end of the inclined surface for dispersion of the stream of molten slag discharged from the inclined surface;
(c) one or more water addition devices for adding a controlled amount of water to the molten slag; and
(d) a collection area adjacent to the dispersion device for deposition of solidified slag produced by the dispersion of the molten slag, wherein the solidified slag comprises said substantially dry slag granules and slag wool, and wherein a quantity of the slag wool is less than that which would be produced by granulating the stream of molten slag without addition of the controlled amount of water.

15. The apparatus of claim 14, wherein the dispersion device comprises an atomizer in which the molten slag is contacted with a stream of an atomizing fluid.

16. The apparatus of claim 15, wherein the dispersion device comprises a gas atomizer and the atomizing fluid comprises gas.

17. The apparatus of claim 16, wherein at least one of said water addition devices is located proximate to the lower end of the inclined surface and is associated with the gas atomizer, such that the gas and the controlled amount of water added by said at least one water addition device together comprise the atomizing fluid.

18. The apparatus of claim 17, wherein the gas atomizer comprises a blower, and wherein the at least one water addition device located proximate to the lower end of the inclined surface comprises one or more spray nozzles, said spray nozzles being located above and/or below the lower end of the inclined surface.

19. The apparatus of claim 14, wherein the dispersion device comprises a first rotating mechanical element, and wherein at least one of said water addition devices are located between the upper end of the inclined surface and the first rotating mechanical element.

20. The apparatus of claim 19, wherein a slag flow direction is defined between upper and lower ends of the inclined surface, and the inclined surface has a width which is transverse to the slag flow direction;
wherein the apparatus further comprises a flow distribution element, for distributing the flow of the molten slag across the width of the inclined surface; and
wherein the flow distribution element is located between the upper end of the inclined surface and the first rotating mechanical element.

21. The apparatus of claim 20, wherein the one or more water addition devices are located along the slag flow direction between the upper end of the inclined surface and the flow distribution element.

22. The apparatus of claim 21, wherein the one or more water addition devices comprises one or more water spray nozzles provided above the inclined surface and directed downwardly toward the inclined surface.

23. The apparatus of claim 22, wherein the flow distribution element comprises a second rotating mechanical element which extends across the width of the inclined surface, is rotatable about an axis extending transversely across the inclined surface, and extends across substantially the entire width of the inclined surface, and is spaced from the inclined surface by a gap.

24. The apparatus of claim 23, wherein the flow distribution element is cylindrical.

25. An apparatus for the production of substantially dry slag granules, comprising:
(a) an inclined surface having an upper end for receiving a stream of molten slag and a lower end for discharging the stream of molten slag, wherein a slag flow direction is defined between upper and lower ends of the inclined surface, and the inclined surface has a width which is transverse to the slag flow direction;
(b) a gas atomizer proximate to the lower end of the inclined surface for dispersion of the stream of molten slag discharged from the inclined surface with an atomizing gas;
(c) a flow distribution element for distributing the flow of the molten slag across the width of the inclined surface, wherein the flow distribution element is located between the upper end and the lower end of the inclined surface; and
(d) a collection area adjacent to the gas atomizer for deposition of solidified slag produced by the dispersion of the molten slag, wherein the solidified slag comprises said substantially dry slag granules.

26. The apparatus of claim 25, wherein the flow distribution element comprises a rotating mechanical element which extends across the width of the inclined surface, is rotatable about an axis extending transversely across the inclined surface, extends across substantially the entire width of the inclined surface, and is spaced from the inclined surface by a gap.

27. The apparatus of claim 26, wherein the flow distribution element is cylindrical.

28. The apparatus of any one of claims 25 to 27, wherein the gas atomizer is located below the lower end of the inclined surface.

29. The apparatus of any one of claims 25 to 28, wherein the apparatus further comprises one or more water addition devices located proximate to one or more of the upper surface of the inclined surface, the flow distribution element, and/or the gas atomizer, for the purpose of adding water to the molten slag before, during and/or after granulation of the molten slag.

30. A process for the production of substantially dry slag granules, comprising:
(a) providing a stream of molten slag flowing along an inclined surface having an upper end for receiving the stream of molten slag and a lower end for discharging the stream of molten slag, wherein a slag flow direction is defined between upper and lower ends of the inclined surface, and the inclined surface has a width which is transverse to the slag flow direction;
(b) distributing the flow distribution of the molten slag across the width of the inclined surface with a flow distribution element located between the upper end and the lower end of the inclined surface, so as to provide the stream of molten slag with a uniform thickness at the lower end of the inclined surface; and
(c) dispersing the stream of molten slag with an atomizing gas from a gas atomizer immediately after the stream of molten slag is discharged from the lower end of the inclined surface.

31. The process of claim 30, further comprising the addition of water to the molten slag in an amount up to about 1.2 tonnes of water per tonne of slag, wherein the water is added before, during and/or after the step of dispersing the stream of molten slag.
